(19) United States
(12) Patent Application Publication
(10) Pub. No.: US 2008/0019288 A1
(43) Pub. Date: Jan. 24, 2008

(54) SYSTEM AND METHOD FOR MANAGING DOMAIN-STATE INFORMATION

(75) Inventors: Hyoung-shick KIM, Seoul (KR); Myung-soo Chang, Seoul (KR); Sang-hyeon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/697,594

(22) Filed: Apr. 6, 2007

Related U.S. Application Data
(60) Provisional application No. 60/831,463, filed on Jul. 18, 2006.

(30) Foreign Application Priority Data
Nov. 3, 2006 (KR) 10-2006-0108502

(51) Int. Cl. H04L 12/28

(52) U.S. Cl. 370/254

(57) ABSTRACT

A system and method are provided for managing domain-state information. The system includes a client that is connected with a legacy device, and sends a request for domain-state information of the legacy device, and a state-management server that transmits the domain-state information to the client in response to the request.

### CROSS-REFERENCE TO RELATED APPLICATION

This application claims priority from Korean Patent Application No. 10-2006-0108502 filed on Nov. 3, 2006 in the Korean Intellectual Property Office, and U.S. Provisional Patent Application No. 60/831,463 filed on Jul. 18, 2006 in the United States Patent and Trademark Office, the disclosures of which are incorporated herein by reference in their entirety.

### BACKGROUND OF THE INVENTION

1. Field of the Invention

Methods, systems and apparatuses consistent with the present invention relate to a system and method for managing domain-state information, and more particularly, to managing the domain-state information described in CORAL.

2. Description of the Related Art

CORAL is a specification for improving interoperability between digital rights management (DRM) technologies. The concept of a “domain”, which represents a logical set of multiple devices, is presented in CORAL, and there is a domain-management server that manages such a domain. The domain-management server manages domains using domain-state information of each device so that each device can belong to only one domain. Further, content can be shared between devices belonging to the same domain.

Here, each device operates as a client of the domain-management server, and manages domain-state information by having the structure illustrated in FIG. 1.

Referring to FIG. 1, a client 100 is a device that includes a domain-state-storage module 120 storing domain-state information and a state-query module 110, and that can be operated according to CORAL.

For example, in the case where the client participates in an arbitrary domain A, and intends to replay content that can be shared by devices belonging to domain A, the client 100 first connects to a domain-management server. Then, the connected domain-management server sends a transmission request for domain-state information stored in the domain-state-storage module 120. Here, the state-query module 110 asks the domain-state-storage module 120 about domain-state information, and in response, the domain-state-storage module 120 provides the stored domain-state information to the state-query module 110, and the domain-state information is transmitted to the domain-management server.

Here, the domain-state information can be divided into first state information, second state information, and third state information.

The first state information indicates that the current client does not belong to any domain, the second state information indicates that the current client belongs to an arbitrary domain and can operate as a member constituting the domain, and the third state information indicates that the current client belongs to an arbitrary domain but can not operate as a member constituting the domain.

Hence, in the case where domain-state information stored in the client 100 is the first state information, the domain-management server allows the client 100 to change the domain-state information of the client to the second state information about domain A, and the changed domain-state information is stored in the domain-state-storage module 120 of the client 100. Here, the second state information is changed to the third state information after the predetermined time

In the case where the domain-state information stored in the client 100 is the second or third state information about domain B, not domain A, the client 100 can be a member constituting domain A because one device should support CORAL, which specifies that a device should belong to only one domain. The domain and domain-state information are described in more detail in “Core Architecture V 3.0” and “Ecosystem V 1.0” of CORAL.

Further, the state-query module 110 and the domain-state-storage module 120 should be secured within the client 100, and the domain-state information stored in the domain-state-storage module 120 should be changed by a third party.

Hence, devices that support CORAL store their domain-state information in each security area, and because the domain-management server checks the stored domain-state information, CORAL can be supported.

However, because a conventional device (hereinafter called a “legacy device”) that does not support CORAL does not have the state-query module 110 and the domain-state-storage module 120 as illustrated in FIG. 1, it is not possible to operate as a member of an arbitrary domain by participating in the domain, which is a problem. Hence, the concept of a virtual client has been introduced to overcome this problem.

That is, by connecting a legacy device to a computing device connected to the domain-management server, a virtual client is formed as if the computing device and the legacy device were operating as one client. Here, the state-query module 110 and the domain-state-storage module 120 are set in the computing device as in FIG. 1.

However, such a case violates the rule of CORAL that a device should belong to only one domain, which is explained with reference to FIG. 2 in the following.

Referring to FIG. 2, in the case where a legacy device 200 is connected to the first computing device 210 to form a virtual client, if the state information stored in the virtual client is the first state information, the domain-state information of the virtual client is changed to the second state information, and the legacy device 200 can operate as a member of domain A. Here, the domain-state information is stored in the first computing device 210, not the legacy device 200.

Then, in the case where a user connects the device 200 and the second computing device 140 to form a virtual client, because the device 200 has become a member of domain A, it cannot be a member of domain B according to CORAL.

However, because the domain-state information is actually stored in the second computing device 220, and the second computing device 220 does not know that the device 200 is a member of domain A, in the case where the domain-state information stored in the second computing device 220 is the first state information, the device 200 belongs to domain A and domain B.

Hence, if a client supports the conventional virtual client structure, the device constituting the virtual client can operate as a member of numerous domains.

Therefore, the concept of a virtual client is not harmonized with basic rules of CORAL, and the conventional legacy device that does not support CORAL can operate as a member of more domains than a device that supports CORAL.

### SUMMARY OF THE INVENTION

The present invention provides a system and method for managing domain-state information, which allows a legacy device to operate as a member of an arbitrary domain while supporting CORAL by having a separate server that stores and manages domain-state information of each legacy device.

According to an aspect of the present invention, there is provided a system for managing domain-state information, the system including a client that is connected with a legacy device, and sends a request for domain-state information of the legacy device, and a state-management server that transmits the domain-state information to the client in response to the request.

According to another aspect of the present invention, there is provided a method of managing domain-state information, the method including connecting to a legacy device, sending a request for domain-state information of the connected legacy device to a server that manages domain-state information of multiple legacy devices, and receiving domain-state information of the connected legacy device from the server.

According to another aspect of the present invention, there is provided a client including a device-connection module connected with a legacy device, and a state-query module that sends a request for domain-state information of the connected legacy device if the device-connection module senses the connection with the legacy device.

According to another aspect of the present invention, there is provided a state-management server including a state-information-storage module that stores domain-state information of multiple legacy devices, and a control module that extracts domain-state information of the connected legacy device from the state-information-storage module, and transmits the extracted information to the client in response to the request for the domain-state information of the connected legacy device connected to the client.

### BRIEF DESCRIPTION OF THE DRAWINGS

The above and other aspects of the present invention will become apparent from the detailed description of exemplary embodiments and the attached drawings, in which:

FIG. 1 illustrates a method where a client supporting the conventional CORAL manages domain-state information.

FIG. 2 illustrates a problem due to the conventional virtual client.

FIG. 3 illustrates a system for managing domain-state information according to an exemplary embodiment of the present invention.

FIG. 4 is a block diagram illustrating the structure of a client according to an exemplary embodiment of the present invention.

FIG. 5 is a block diagram illustrating the structure of a state-management server according to an exemplary embodiment of the present invention.

FIG. 6 illustrates a process where a legacy device participates in a domain according to an exemplary embodiment of the present invention.

FIGS. 7A and 7B illustrate a data structure for sending a request for domain-state information, and the data structure for responding to the request according to an exemplary embodiment of the present invention.

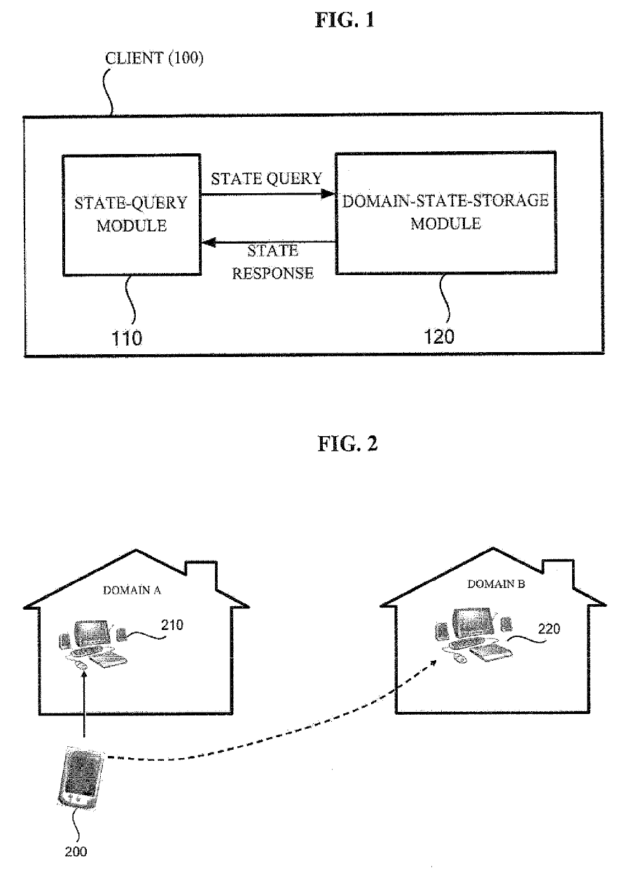

### DETAILED DESCRIPTION OF EXEMPLARY EMBODIMENTS OF THE INVENTION

Exemplary embodiments of the present invention will be described in detail with reference to the accompanying drawings.

The present invention may be understood more readily by reference to the following detailed description of exemplary embodiments and the accompanying drawings. The present invention may, however, be embodied in many different forms and should not be construed as being limited to the exemplary embodiments set forth herein. Rather, these embodiments are provided so that this disclosure will be thorough and complete and will fully convey the concept of the invention to those skilled in the art, and the present invention will only be defined by the appended claims.

The exemplary embodiments are described hereinafter with reference to flowchart illustrations of user interfaces, methods, and computer program products. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that are executed on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

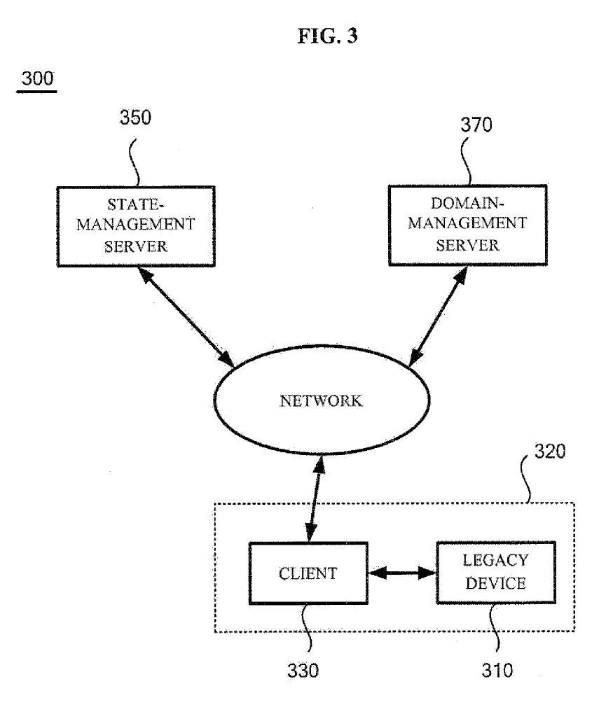

FIG. 3 illustrates a system for managing domain-state information according to an exemplary embodiment of the present invention.

Referring to FIG. 3, a domain-state-information-management system 300 includes a virtual client 320 consisting of a client 330 and a legacy device 310, and a state-management server 350 that manages domain-state information, and a domain-management server 370 that manages domains.

In the case where a user intends to participate in an arbitrary domain managed by the domain-management server 370, change domain-state information, or leave the domain to which it belongs, the legacy device 310 connects to the client 330. Here, it is assumed that the legacy device 310 is an MP3 player that is not supported by CORAL, and the client 330 is a personal computer.

FIG. 4 illustrates the structure of the client 330. Referring to FIG. 4, the client 330 includes a device-connection module 332, a control module 334, a state-query module 336, and a server-connection module 338.

The device-connection module 332 is a communication module connected with the legacy device, and the server-connection module 338 is a network-interface module connected to the state-management server 350 or the domain-management server 370 through the network.

In the case where the device-connection module 332 senses the connection of the legacy device 310, the control module 334 allows the state-query module 336 to send a request for domain-state information of the connected legacy device to the state-management server 350.

The state-query module 336 generates a message for requesting domain-state information of the control of the control module 334, and transmits the generated message to the state-management server 350 through the connection module 338 using the known network address of the state-management server.

The virtual client 320, consisting of the legacy device 310 and the client 330, connects to the state-management server 350 through the network, whereby the domain-state information of the virtual client 320 is managed. Here, the client 330 connects to the state-management server 350 using, for example, Uniform Resource Locator (URL) information of the state-management server 350.

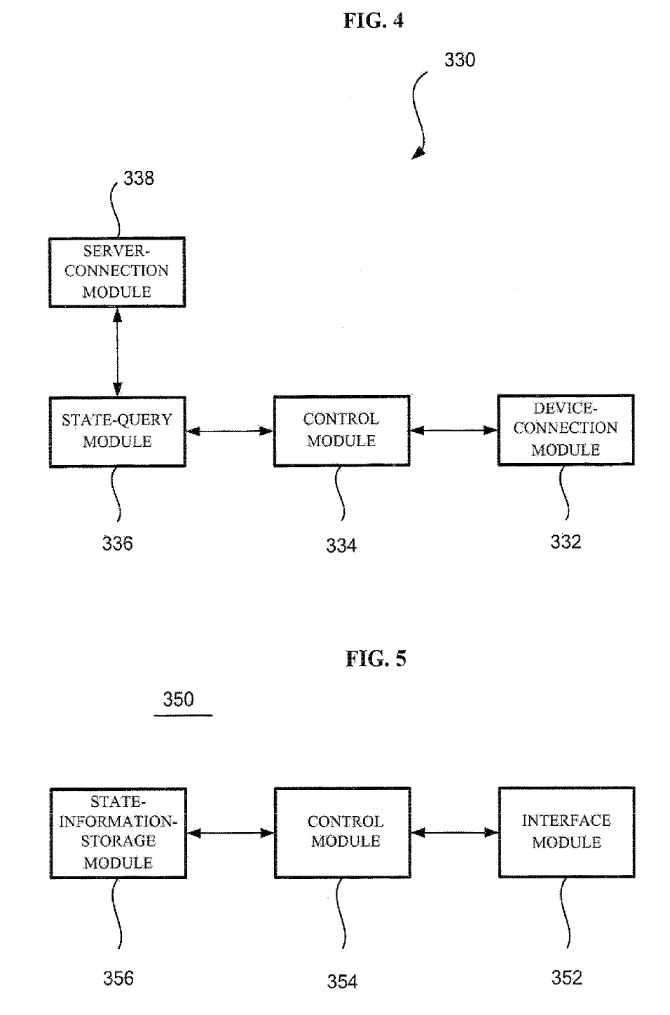

FIG. 5 specifically illustrates the structure of the state-management server 350. Referring to FIG. 5, the state-management server 350 includes an interface module 352, a control module 354, and a state-information-storage module 356.

The interface module 352 is a network-interface module connected to the domain-management server 370 or the virtual client 320 through the network.

The state-information-storage module 356 stores domain-state information of the legacy device 310.

If the control module 354 receives a request for domain-state information of the legacy device 310 from the client 330, it retrieves domain-state information stored in the state-information-storage module 356, and transmits domain-state information retrieved through the interface module 352 to the client 330.

The state-management server 350 transmits domain-state information of the virtual client 320 to the domain-management server 370, and the domain-management server 370 can authorize the legacy device 310 to operate a member of the domain depending on the transmitted domain-state information.

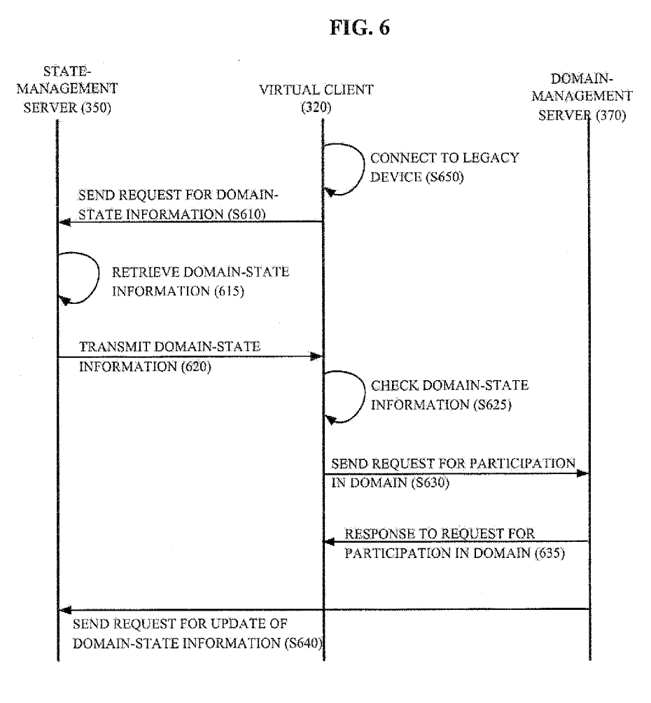

FIG. 6 illustrates a process where a legacy device participates in a domain according to an exemplary embodiment of the present invention.

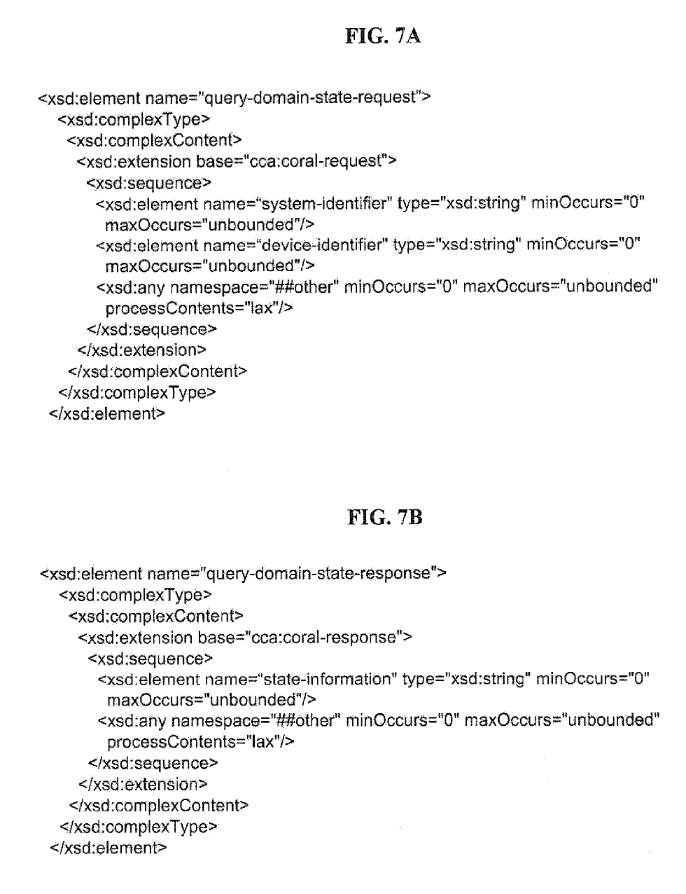

First, a legacy device connects to the client 330 (S650), and the virtual client 320 is formed. Then, the virtual client 320 sends a request for domain-state information of the connected legacy device to the state-management server 350 (S610). An example of the structure transmitted for the request is described in FIG. 7A.

Referring to FIG. 7A, a string-type device-identifier element is included, which can be understood as identification information for identifying the connected legacy device. That is, in the case where the virtual client 320 sends a request for domain-state information to the state-management server 350, the device identification information of the connected legacy device is transmitted together. Further, the virtual client 320 stores address information (e.g., URL information) on the network of the state-management server 350, and it is possible to connect to the state-management server 350 using the stored address information.

The state-management server 350 receiving a request for domain-state information from the virtual client 320 retrieves domain-state information of the connected legacy device 350 using the received device identification information (S615), and transmits the retrieved domain-state information to the virtual client 320 using the data structure, as illustrated in FIG. 7B (S620).

Referring to FIG. 7B, a string-type state information is included, which represents domain-state information retrieved by the state-management server 350.

The virtual client 320 checks the transmitted domain-state information (S625), and in the case where the domain-state information is the first state information, that is, state information that indicates that the current legacy devices does not belong to any domain, the virtual client 320 sends a request for participation in the domain to the domain-management server 370 (S630). Here, the virtual client 320 can transmit the domain-state information to the domain-management server 370.

The domain-management server 370 responds to the request by issuing a membership token to the virtual client 320 (S635). Here, the membership token indicates that the legacy device constituting the virtual client 320 belongs to an arbitrary domain, and can be understood as an authority to replay various content provided within the domain to which the legacy device belongs.

Further, before the legacy device belongs to the domain, the domain-state information is the first state information, but now because the legacy device belongs to a certain domain due to the domain-management server 370, the domain-state information should be changed to the second state information, that is, the domain-state information indicating that the legacy device can operate as a member constituting the domain. Hence, the domain-management server 370 sends a request for the update of domain-state information to the state-management server 350 (S640), and in response to the request, the state-management server 350 changes the stored domain-state information of the legacy device, and stores the changed information in the state-information-storage module 356.

Further, in S625, in the case where the domain-state information is the third state information, that is, the information indicating that the device belongs to a certain domain, but cannot operate as a member of the domain, the virtual client 320 can send a request for a change of the third state information to the second state information, or the virtual client 320 can change the domain-state information to the second state information. In the case of a legacy device having domain-state information of the second state information, because the state-management server 350 can automatically change the second state information to the third state information after the predetermined time, an operation to change the changed domain-state information to the second state information is necessary. In the case where a change of domain-state information between the second state information and the third state information occurs, the state-management server 350 stores the changed domain-state information in the state-information-storage module 356.

Further, in the case where a legacy device belonging to a certain domain intends to participate in another domain, it should leave the domain to which it belongs. Here, the virtual client sends a request to leave the domain, to which it belongs, to the domain-management server, and the domain-management server sends a request to change the domain-state information of the legacy device constituting the virtual client, which requested to leave, to the first state information, to the state-management server. The state-management server that received the request changes domain-state information of the legacy device that intends to leave to the first state information, and stores the changed information.

The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

It should be understood by those of ordinary skill in the art that various replacements, modifications and changes may be made in the form and details without departing from the spirit and scope of the present invention as defined by the following claims. Therefore, it is to be appreciated that the above described embodiments are for purposes of illustration only and are not to be construed as limitations of the invention.

According to the exemplary embodiments of the present invention, a legacy device can operate as a member of an arbitrary domain while supporting CORAL.

What is claimed is:

1. A system for managing domain-state information, the system comprising:
a client that is connected to a legacy device, and sends a request for domain-state information of the legacy device; and
a state-management server that transmits the domain-state information to the client in response to the request.

2. The system of claim 1, wherein the client provides device-identification information of the legacy device to the state-management server, and the state-management server retrieves the domain-state information based on the device-identification information, and transmits the retrieved information to the client.

3. The system of claim 1, wherein the domain-state information comprises one of first state information indicating that the legacy device does not belong to any domain, second state information indicating that the legacy device currently belongs to a domain and can operate as a member constituting the domain, and third state information indicating that the legacy device currently belongs to a certain device but cannot operate as a member constituting the domain.

4. The system of claim 3, further comprising:
a domain-management server that manages domains,
wherein if domain-state information transmitted to the client is the first state information, the client sends a request for participation in the domain to the domain-management server, and the domain-management server responds to the request, thereby participating in the domain.

5. The system of claim 4, wherein the domain-management server sends a request for an update of the domain-state information to the state-management server, and the state-management server updates the domain-state information.

6. A method of managing domain-state information, the method comprising:
connecting to a legacy device;
sending a request for domain-state information of the connected legacy device to a server that manages domain-state information of a plurality of legacy devices; and
receiving domain-state information of the legacy device from the server.

7. The method of claim 6, wherein the sending the request comprises transmitting device-identification information of the connected legacy device to the server.

8. The method of claim 6, wherein the domain-state information comprises one of first state information indicating that the legacy device does not belong to any domain, second state information indicating that the legacy device currently belongs to a certain domain, and can operate as a member constituting the certain domain, and third state information indicating that the legacy device currently belongs to a certain device, but can not operate as a member constituting the domain.

9. The method of claim 8, further comprising:
sending a request for participation in the domain to the domain-management server; and
updating the received domain-state information,
if the received domain-state information is the first state information.

10. A client comprising:
a device-connection module connected to a legacy device; and
a state-query module that sends a request for domain-state information of the connected legacy device if the device-connection module senses connection with the legacy device.

11. A state-management server comprising:
a state-information-storage module that stores domain-state information of multiple legacy devices; and
a control module that extracts domain-state information of a connected legacy device from the state-information-storage module, and transmits the extracted information to a client in response to a request for the domain-state information of the connected legacy device connected to the client.

12. The server of claim 11, wherein the domain-state information of the connected legacy device stored in the state-information-storage module is updated in response to domain participation of the connected legacy device.

13. The server of claim 11, wherein the domain-state information of the connected legacy device stored in the state-information-storage module is updated, in response to the connected legacy device leaving the domain.
